(19) United States
(12) Patent Application Publication
(10) Pub. No.: US 2025/0005670 A1
(43) Pub. Date: Jan. 2, 2025

(54) ASSET ALLOCATION FOR OPTIMIZATION OF COLLECTIVE ECONOMIC BENEFIT

(71) Applicant: Thomas Hecht, Wilbraham, MA (US)

(72) Inventor: Thomas Hecht, Wilbraham, MA (US)

(21) Appl. No.: 18/216,329

(22) Filed: Jun. 29, 2023

(51) Int. Cl. G06Q 40/06

(52) U.S. Cl. CPC G06Q 40/06

(57) ABSTRACT

A method for allocating asset ownership for maximized collective economic benefit is provided. A computer receives information about a user and an asset used or to be used by the user. The computer identifies areas based at least on the received information in which the user's actual or planned use of the asset does not take maximum economic benefit associated with ownership of the asset. The computer searches a database describing a plurality of asset management entities with legal and structural characteristics suited to achieving maximum economic benefits associated with ownership of the asset. The computer selects a first asset management entity of the plurality of entities to match with the user. The computer executes a transaction providing ownership of the asset to the first entity and providing usage of the asset to the user, the transaction returning a portion of the economic benefits realized to the user.

### CROSS REFERENCE TO RELATED APPLICATIONS

None

### FIELD OF THE DISCLOSURE

The present disclosure is in the field of asset management. More particularly, the present disclosure teaches systems and methods of creating specialized asset ownership entities optimally structured to own assets, maximize economic benefits of ownership, and share at least some of the maximized benefits with users as at least incentive to the users to participate.

### BACKGROUND

In a capitalist free market economy and democratic society, ownership of assets is traditionally viewed as a sign of economic strength, power, and prestige. Private property rights are a core pillar of the American ethos. A central tenet of the Founders' philosophy was and remains control of one's own destiny and wellbeing which equated to owning property, particularly tangible property, both real and personal. Expansion of owned property and continued acquisition of property supports prestige in the American mind.

The industrial revolution, which was based on manufacturing and mechanized harvesting of resources, meant machines and hard, productive assets. While capital, the lower right side of the balance sheet is what truly matters, assets on the left side of the balance sheet, even if leveraged with heavy debt, are what Americans take pride in.

Legal ownership of assets provides psychological and economic benefits. Usage of assets provides a separate set of benefits which in most Americans' minds are closely tied to ownership benefits. But ownership and usage are in fact separate economic concepts that need not be coupled. Americans are gradually realizing that ownership and usage are not the same thing and can, in fact, be decoupled. An owned asset that performs no useful function, such as a working motor vehicle that rarely leaves its garage, is less valuable than another vehicle that is not owned but is instead leased but provides daily transportation for the user.

While a great piece of art of course has significant intrinsic value, Americans in an affluent and mobile society increasingly value experiences. The value of experiences and benefits derived therefrom can be compromised or lessened by the burden of owning assets needed to make such experiences happen. A boat owner may come to realize that vacationing on a cruise ship is less burdensome. An owner of a large recreational vehicle may eventually find that his/her resources and time are better spent on a professionally guided tour.

Ownership of large assets has never been as exciting or rewarding as it appeared. Americans will eventually see the benefits of use by itself as opposed to use combined with ownership.

Institutions and individuals are incentivized by short-term gains, quarterly reporting, and political term considerations. The race for short-term gains has created a system characterized by unsustainability and overconsumption in a finite world. Systems and methods provided herein as described below seek to perpetuate sustainability and conscious capitalism.

Recent trends including the rise of Uber and Airbnb wherein transportation and short-term lodging, respectively, are disintermediated from ownership exemplify the gradual change in consumer consciousness that partially forms the basis for the present disclosure. As American and advanced western societies evolve away from manufacturing and industrial economies, the ownership of hard assets will receive less emphasis.

### BRIEF DESCRIPTION OF THE FIGURE

FIG. 1 is a block diagram of a system of asset allocation for optimization of collective economic benefit according to an embodiment of the present disclosure.

### DETAILED DESCRIPTION

Systems and methods provided herein separate asset ownership from asset use. Use of an asset need not equate to ownership of the asset. While renting and leasing are long established concepts, the present disclosure teaches creation of a specialized entity structured for maximum economic benefit to own assets, lease assets to users, and pass benefits associated with their superior structure back to the user.

When a user originally owned a particular asset, ownership may be reallocated from that user using the asset but not receiving maximum advantage or benefit to such a specially structured ownership entity. The user, who is the original or previous owner of the asset, continues to enjoy usage of the asset on a long-term basis.

The new owner, by virtue of its specialized structure including legal, accounting, and tax status, receives economic benefits that exceed the benefits that the user would have received had the user continued to own the asset. In exchange for the user relinquishing or waiving ownership and agreeing to the arrangement described herein, the user receives a portion of the superior economic return realized by the ownership entity. Maximum economic benefit is realized and shared and both parties benefit whereas economic benefit would have been foregone and forfeited had the user not entered into the arrangement described. The collective benefit realized exceeds what the user would have received on its own.

Systems and methods provided herein extend beyond tangible assets such as real property, for example land and buildings, or personal property such as large, long-lived assets, for example vehicles or machines. Intangible but important financial assets such as employer matching on employee retirement accounts or employee stock purchase plans (ESPP) are subject to an economic and psychological phenomenon similar to the above as employees often fail to take full advantage of benefits available to them. Systems and methods provide similar ownership or management vehicles to temporarily control such assets on behalf of employees such that maximum value can be earned until the employee is ready to receive the account or other asset.

In both cases of tangible assets and financial assets as well as other types of assets, the specialized entity is created and structured to own or control property for maximum collective benefit. Incremental and maximized benefit arising from assets' ownership by the entity is partially returned to the user as at least an incentive to the user to participate.

The present disclosure teaches disintermediating an asset from its user. It is not necessary for a user of an asset to own the asset and in many cases, it makes more economic sense for the user not to own the asset. From an economic standpoint, the user is better off with the asset held by another party because more economic benefit is available to the other than to the user.

Because more benefit is realized by the other party owning the asset than the user and some of the greater benefit can be returned to the user, it makes more sense for the user to have the other party own the asset. Some of this may go against the hard capitalist instincts of many people to legally own and therefore control assets. But insistence on legally owning an asset can have significant opportunity costs when the asset's value is better realized when the asset is owned by another party than the user. Owning the asset allows the user to feel like he has more control, but that desire for control actually imposes significant opportunity costs on the owner that he may not be considering.

The present disclosure is predicated on placing ownership with the party who can derive the most economic benefit from the ownership. The party then shares the economic benefit with the user who realizes greater benefit than if he the user owned the asset. The party that owns the asset can later transfer ownership to other asset owners who may extract even greater benefit and thereby pass a portion of that greater benefit to the user.

Systems and methods are provided for ownership entities to be structure for maximum non-user ownership benefit. From accounting, tax, legal, and regulatory perspectives, such entities may exist solely or primarily to hold assets, benefit maximally from their own structure, and pass benefits back to users in various forms.

Over the useful life of an asset, ownership may transition between different ownership entities based on economic and other factors. Demand for a type of asset inevitably changes over a long term based on the nature of the asset, the changing quantity and characteristics of the user population, and competing asset types, and innovative replacements that may be cheaper, longer lived, and offering greater functionality.

The system therefore contemplates that a given asset during its useful life may be owned by a succession of ownership entities in addition to, of course, having many users. During the asset's life, the system may determine which prospective user who has registered interest in the asset is best suited to take possession of and begin using the asset at a given time during the life of the asset. For an asset or group of assets in a pool, the system monitors demand for the assets and analyzes specific characteristics of prospective users.

The system further tracks long term demand for various asset types with objectives including accumulating or acquiring assets only when needed. An objective herein is to efficiently acquire and use assets which enhances economic returns and benefits for asset ownership entities as well as users.

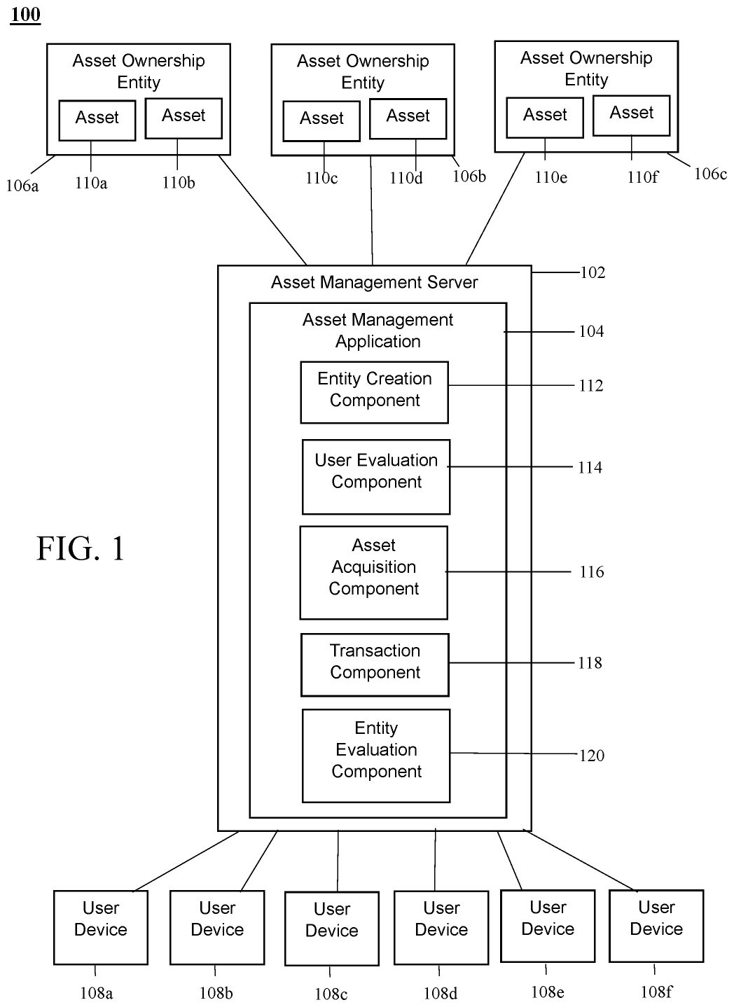

Turning to the figure, FIG. 1 is a block diagram of a system of asset allocation for optimization of collective economic benefit according to an embodiment of the present disclosure. FIG. 1 illustrates components of a system 100 comprising an asset allocation server 102 and an asset allocation application 104, referred to hereafter for brevity as the server 102 and the application 104, respectively.

System 100 also comprises asset ownership entities 106a-c, referred to hereafter for brevity as the entity or entities 106a-c. System 100 also comprises user devices 108a-e in possession of users and assets 110a-f.

System 100 also comprises five components that may be components of the application 104: an entity creation component 112, a user evaluation component 114, an asset acquisition component 116, a transaction component 118, and an entity evaluation component 120.

The server 102 is at least one physical computer that may be situated at more than one geographic location. The application 104 executes at least on the server 102 and may comprise multiple software applications, modules, and components stored and executing on devices associated with the server 102.

Asset ownership entities 106a-c, or entities 106a-c, are specialized legal units formed to own assets 110a-f for the benefit of extracting maximum or nearly maximum economic value and passing much of the value back to users of the assets 110a-f. The entities typically have legal, accounting, and tax structures to maximize collective economic benefits of their owning but not using the assets. Typically, entities 106a-c pass benefits of ownership back to users of the assets 110a-f.

Systems and methods are predicated on an economic fact that many users of assets 110a-f, both consumer and commercial, do not take full advantage of ownership of their assets from accounting, economic, tax, regulatory, and other perspectives. They therefore are foregoing benefits or “leaving money on the table.” Entities 106a-c are provided herein to own such assets, extract maximum collective benefit, and share some or all the extracted benefits with users.

Assets 110a-f may be large assets such as motor vehicles or buildings. Assets 110a-f may preferably be productive assets that a user needs as opposed to a leisure-oriented asset such as a pleasure boat that they might more readily abandon once no longer needed. Of course, credit rating of a user is also a consideration as the user will in most cases be making installment or lease payments to the entity 110a that owns the asset or with the application 104.

The entity creation component 112 of the application 104 creates new entities 106a-c when the need arises. In embodiments, an entity 106a-c can own more than one asset 110a-f and in many cases, it may own multiple assets 110a-f depending on the asset type, the user, and other circumstances.

The user evaluation component 114 examines users, their immediate and future needs, and their financial and credit records. The user evaluation component 114 makes decisions and recommendations about which users should receive assets 110a-f and when they should receive them.

The asset acquisition component 116 secures possession and ownership of assets 110a-f to be placed with entities 106a-c. In some instances, an asset 110a-f will be acquired from the user that previously owned it. In other cases, the asset acquisition component 116 acquires an asset 110a-f from another party. The asset 110a-f may in many cases be new when it is first placed with the entity 106a that will own the asset 110a-f and enter into a transaction with a user as described herein.

The transaction component 118 of the application 104 oversees execution of transactions between entities 106a-c and users. This includes any negotiation, setting of terms, and documentation. The terms include how much of the collective benefits will be returned to the user.

The entity evaluation component 120 reviews new entities 106a-c that are being created and reviews existing entities 106a-c for regular reviews or when problems are reported. The entity evaluation component 120 makes determinations and advises on whether a given new or existing entity 106a is suited to enter into a transaction with the user for the particular asset 110a the user wants.

Businesses have lower taxes and are minimally restricted. Individuals have a progressive tax code and are restricted. Systems and methods therefore move assets to the most favorable set of conditions and mimic ownership within the constraints.

Because a large percentage, perhaps 90%, of US individual tax filers file the standard deduction, they receive no tax benefits for charitable deductions. Systems and methods add means to capture the marginalized capital as contributions through businesses. Similar to how the present disclosure converts individual assets to business assets, the present disclosure promotes business and nonprofit assets to coexist.

The present disclosure also provides for a collective system of pools of assets and groups of users and ownership entities 106a-c working together in matching assets and users that need them the assets. The system could execute method steps of 1) opting in assets, 2) formalizing the ownership of the assets into the most beneficial set of conditions, 3) enabling participants, including users, ownership entities 106a-c, and others, to elect how to put those assets to use, and 4) users receiving value in ownership entities 106a-c and the collective value of assets. Securities may be created that are backed by the pooled system assets, tangible and intangible, that can be used as a currency within the system.

The present disclosure also addresses the aforementioned problem of the high percentage of US taxpayers electing the standard deduction and therefore receiving no tax benefit from charitable contributions. Businesses can donate and deduct those charitable contributions, so the system can solve aspects of that problem by deducting as business deductions or gifting contributions to someone who is eligible.

As an extension of, non-profit entities can now own for-profit entities and the mechanism will apply that at a large scale, so that every commodity can be owned by a non-profit. The end goal is similar to the primary embodiment provided herein. The system is matching intended resources with their goals in the most optimized, tax efficient, way.

The present disclosure also provides for a systematic disaggregation and reassembly of companies into more efficient structures with deconsolidating assets to minimize risk, maximize tax sheltering, and maneuvering effectively but of course legally and ethically against regulation. This coincides with the broader idea of evolving laws and constraints. Assets are envisioned as existing in a hybrid state as personal assets and business assets are available for non-profit monetization. Many assets may be assigned/owned by many entities concurrently.

The present disclosure also provides for non-pooling, one-for-one transactions. Anyone who elects the standard deduction (the aforementioned large percentage of taxpayers) cannot deduct charitable contributions. However, if a first person itemizes and a second person does not itemize and they sit next to each other in a church or other charitable function, the second person could legally gift his/her donation to the first person who gets the deduction and saves 35%. Because of a progressive tax system, the 35% for one person may be 25% for another, so there is a level of optimization.

Another element that is that is important throughout this system is trust. Many individual assets can't be legally transferred, such as the charitable deduction (benefits like ESPP/401k and lawsuits), so where the system is able, it creates securities to match an asset cycle.

The present disclosure also redirects traditional charitable deductions into stable value-generating assets run by this system. The system gets compensated as operators. This structure may be compelling because providing a platform for non-profits to generate stable profits is as a better alternative to more traditional fundraising. For example, linking a social cause to a competitively priced commoditized transaction (ex: sports betting to any goods and service) is a sustainable competitive advantage.

The present disclosure also opts in anything with potential value/utility and provides mechanisms to monetize it/broker value and share the net gains from things like tax savings, disintermediation of middlemen, value preservation, utility as simple as a feeling secure (ex: Maslow's hierarchy of needs). All this value can be transferred within a system to best match individual or collective utility.

The present disclosure also can set up future transactions based on predictable changes in utility, like transferring a house or other dwelling from an empty nester to a new family and balance out transactions using the security of the system with future promises. This can be done 1:1, matching parties' individual utilities, or in a pooling fashion, similar to insurance risk pooling and pooling of like future promises.

The system may support an overall arbitrage structure by converting assets to hybrid assets (ex: personal, business, government, non-profit) via transfer and public-private partnerships. Hybrid alternative institutions, for example debt underwriting, insurance, and derivatives, may allow for superior risk to reward profiles. The sharing of information enables for better decision making for an array of circumstances for collaborators. For example, sharing results from a vetting process or due diligence may bring value and opportunity to recycle otherwise wasted effort such as referring quality candidates or deal flow between entities and to further enhance the transfer and portability of assets and liabilities between entities. Institutional disaggregation and reassembly from opt into to more tax and operationally efficient business structures may also be provided for herein.

The system may broker asymmetric and consequential deals using existing and alternative capital in a way that minimizes acquisition costs and maximizes lifetime value of assets. This is an alternative capital investment bank and hybrid asset that facilitates interdependent activities between institutions, business, and individuals.

Regarding non-profit institutional transformation, the system may transform non-profit infrastructures to for-profit, social enterprise systems. This may loosely parallel the presently popular narrative with ESG (environmental, social, and corporate governance) funds containing public equities. The system may operate and collect fees.

The system may convert revenue generating nonprofit organizations to for-profit B-Corporations. Health care clinics, Goodwill, and YMCA-gyms may be included to enhance the ability to serve their mission. This dovetails with proprietary deal flow in an overvalued market.

Systems and methods may also apply to what is commonly referred to as the Newman's Own Philanthropic Exception. Revenue may be earned as business operators for non-profit owned businesses and platforms. A non-profit marketplace may take shape, competitive with any commodity that has the distinct advantage of financing charitable and social enterprising activities. The system may direct marginalized charitable to ESG funds within marketplace systems. The system may also earn buy in from collective influence and resources (tangible/intangible) of non-profit boards and opt in contributions to the vision.

Public/Private partnerships may be supported via social enterprise narratives to overcome regulatory hurdles and bipartisanship. Hybrid funds may be mapped to UN 17 sustainable development goal, driven by the system. Partnerships with civic minded influencers may be supportive comprising retired/political candidates, board members of for/non-profits, and athlete and celebrities who wish to be influencers and support various causes.

Systems and methods also support the disaggregation and reassembly of existing entities/institutions to enhance interdependence between entities and repeat and scale value adds. An example is in the practice of accounting. People prefer symmetry and as a result, most companies have their year-end as December 31, when in reality companies' year end could be any other day of the year. The December 31 dynamic creates a supply and demand mismatch for regulated and/or deadline-driven services including audit and tax, resulting in a needless premium for those services. Similarly, month closes are often the last day of a month when it could be any day.

Recurring functions such as monthly or quarterly closing of books have ebbs and flows of workload. The present disclosure provides for multiple entry points (ex: bottom-up, top-down, middle-out). Functions from entities can be siphoned and optimized in a pooling fashion. In the example, systems and methods can funnel the accounting function to a specialized accounting entity and restate a more optimal year-end that balances with the fulfillment entity. This method can apply to many functions within a company or institution.

Ownership of assets can be held by multiple co-owners concurrently. For example, equipment and employees for a trucking company could be legally domiciled under more than one legal entity to enable interchangeable fulfillment among multiple carriers in a pool.

In an embodiment, a method for allocating asset ownership for maximized collective economic benefit is provided. The method comprises a computer receiving information about a user and an asset used or to be used by the user. The method also comprises the computer identifying areas based at least on the received information in which the user's actual or planned use of the asset does not take maximum economic benefit associated with ownership of the asset. The method also comprises the computer searching a database describing a plurality of asset management entities with legal and structural characteristics suited to achieving maximum economic benefits associated with ownership of the asset. The method also comprises the computer selecting a first asset management entity of the plurality of entities to match with the user. The method also comprises the computer executing a transaction providing ownership of the asset to the first asset management entity and providing usage of the asset to the user, the transaction returning a portion of the economic benefits realized by the entity in the transaction to the user.

The method also comprises the computer evaluating the user's financial and tax status described in the received information in identifying areas in which the user's actual or planned use of the asset does not take maximum economic benefit associated with ownership of the asset. The method also comprises the computer selecting the first asset management entity based at least in part on the entity's ability to extract economic benefit from its ownership of the asset.

The method also comprises the computer selecting the first asset management entity based on at least one of legal, structural, tax, and financial strengths of the entity compensating for at least one of legal, structural, tax, and financial weaknesses exhibited by the user. The method also comprises the computer overseeing a program that matches users of assets with asset management entities to promote optimal realization of economic benefits from use of the asset by the user and ownership of the asset by an asset management entity selected by the computer to own the asset.

Over a useful life of an asset in the program, the asset may have multiple owners and may have multiple users. The method also comprises the computer invoking a change of ownership of the asset based on an observed decline in economic benefits of the transaction, due in part to changes in at least legal, structural, tax, and financial strengths of the asset management entity presently owning the asset. The method also comprises the computer endeavoring to maximize economic benefit of the transaction to maximize return of the portion of benefits to the user as compensation to the user for participating in the program.

In another embodiment, a method for deriving benefit from funds forfeited by employees under employer-sponsored programs is provided. The method comprises a computer receiving funds from an employer, the funds representing employer contribution amounts forfeited by employees during selection of employer-sponsored compensation programs. The method also comprises the computer investing the received funds with risk, return, and maturity characteristics aligning with projected needs of the employees. The method also comprises the computer sharing returns on the invested funds with employer and employees during duration of employee ownership of assets associated with the programs. The method also comprises the computer paying a first portion of the invested funds and returns on the invested funds to employees upon liquidation of the assets and paying a second portion of the invested funds and returns on the invested funds to the employer upon the liquidation.

The employer-sponsored compensation program is a 401(k) plan, and the employer contribution is an employer matching amount permitted under 401(k) guidelines. The employer-sponsored investment program is an employee stock purchase plan (ESPP), and the employer contribution is an employer subsidy permitted under guidelines of the ESPP. The method also comprises the computer paying the first portion to incentivize employees to more actively participate in the programs. The method also comprises the computer paying the first portion to support the employer building employee loyalty and longevity in tenure.

In yet another embodiment, a system for efficiently using assets is provided. The system comprises a computer and application executing thereon that receives a message that a first asset has been added to a pool of assets made available to a customer base for use. The system also determines that a subset of the customer base indicated interest in using the first asset, wherein a first group of customers in the subset do not immediately need the first asset. The system also arranges the subset by chronological time periods of interest expressed by customers in the subset. The system also selects, based on the interested chronological time period of subset customers and on legal and business characteristics of subset customers, a first set of subset customers to receive use of the first asset during specific time periods at least partially matching their chronological time periods of interest, the selection placing the first group for first asset use at a late stage in a useful life of the first asset.

The pool of assets is made available to customers in transactions with asset ownership entities. The system selects asset ownership entities for specific transactions based on the entities' abilities to generate maximum economic benefit from ownership of a subject asset and return a portion of realized benefits to users of the assets in the transactions. The system arranges ownership transactions for the first asset for future execution based on an expected future set of conditions for a user.

The system chronologically allocates usage of the first asset to users in the subset based at least on the users' expressed chronological needs for the first asset and further based on users' fitness to use the first asset, the fitness determined by the system. The system structures transactions with built-in flexibility to accommodate changes in applicable laws. The system assigns assets to combinations of interested users and asset ownership entities considered most optimal based on evaluations by the system.

What is claimed is:

1. A method for allocating asset ownership for maximized collective economic benefit, comprising:
a computer receiving information about a user and an asset used or to be used by the user;
the computer identifying areas based at least on the received information in which the user's actual or planned use of the asset does not take maximum economic benefit associated with ownership of the asset;
the computer searching a database describing a plurality of asset management entities with legal and structural characteristics suited to achieving maximum economic benefits associated with ownership of the asset;
the computer selecting a first asset management entity of the plurality of entities to match with the user;
the computer executing a transaction providing ownership of the asset to the first asset management entity and providing usage of the asset to the user, the transaction returning a portion of the economic benefits realized by the entity in the transaction to the user.

2. The method of claim 1, further comprising the computer evaluating the user's financial and tax status described in the received information in identifying areas in which the user's actual or planned use of the asset does not take maximum economic benefit associated with ownership of the asset.

3. The method of claim 2, further comprising the computer selecting the first asset management entity based at least in part on the entity's ability to extract economic benefit from its ownership of the asset.

4. The method of claim 3, further comprising the computer selecting the first asset management entity based on at least one of legal, structural, tax, and financial strengths of the entity compensating for at least one of legal, structural, tax, and financial weaknesses exhibited by the user.

5. The method of claim 1, further comprising the computer overseeing a program that matches users of assets with asset management entities to promote optimal realization of economic benefits from use of the asset by the user and ownership of the asset by an asset management entity selected by the computer to own the asset.

6. The method of claim 5, wherein over a useful life of an asset in the program, the asset has multiple owners and multiple users.

7. The method of claim 6, further comprising the computer invoking a change of ownership of the asset based on an observed decline in economic benefits of the transaction, due in part to changes in at least legal, structural, tax, and financial strengths of the asset management entity presently owning the asset.

8. The method of claim 1, further comprising the computer endeavoring to maximize economic benefit of the transaction to maximize return of the portion of benefits to the user as compensation to the user for participating in the program.

9. A method for deriving benefit from funds forfeited by employees under employer-sponsored programs, comprising:
a computer receiving funds from an employer, the funds representing employer contribution amounts forfeited by employees during selection of employer-sponsored compensation programs;
the computer investing the received funds with risk, return, and maturity characteristics aligning with projected needs of the employees;
the computer sharing returns on the invested funds with employer and employees during duration of employee ownership of assets associated with the programs;
the computer paying a first portion of the invested funds and returns on the invested funds to employees upon liquidation of the assets and paying a second portion of the invested funds and returns on the invested funds to the employer upon the liquidation.

10. The method of claim 9, wherein the employer-sponsored compensation program is a 401(k) plan, and the employer contribution is an employer matching amount permitted under 401(k) guidelines.

11. The method of claim 9, wherein the employer-sponsored investment program is an employee stock purchase plan (ESPP), and the employer contribution is an employer subsidy permitted under guidelines of the ESPP.

12. The method of claim 9, further comprising the computer paying the first portion to incentivize employees to more actively participate in the programs.

13. The method of claim 9, further comprising the computer paying the first portion to support the employer building employee loyalty and longevity in tenure.

14. A system for efficiently using assets, comprising:
a computer and application executing thereon that:
receives a message that a first asset has been added to a pool of assets made available to a customer base for use,
determines that a subset of the customer base indicated interest in using the first asset, wherein a first group of customers in the subset do not immediately need the first asset,
arranges the subset by chronological time periods of interest expressed by customers in the subset, and
selects, based on the interested chronological time period of subset customers and on legal and business characteristics of subset customers, a first set of subset customers to receive use of the first asset during specific time periods at least partially matching their chronological time periods of interest, the selection placing the first group for first asset use at a late stage in a useful life of the first asset.

15. The system of claim 14, wherein the pool of assets is made available to customers in transactions with asset ownership entities.

16. The system of claim 15, wherein the system selects asset ownership entities for specific transactions based on the entities' abilities to generate maximum economic benefit from ownership of a subject asset and return a portion of realized benefits to users of the assets in the transactions

17. The system of claim 14, wherein the system arranges ownership transactions for the first asset for future execution based on an expected future set of conditions for a user.

18. The system of claim 14, wherein the system chronologically allocates usage of the first asset to users in the subset based at least on the users' expressed chronological needs for the first asset.

19. The system of claim 14, wherein the system structures transactions with built-in flexibility to accommodate changes in applicable laws.

20. The system of claim 14, wherein the system assigns assets to combinations of interested users and asset ownership entities considered most optimal based on evaluations by the system.
